(19) United States
(12) Patent Application Publication
(10) Pub. No.: US 2004/0137130 A1
(43) Pub. Date: Jul. 15, 2004

(54) Low-fat oil-fried food

(76) Inventors: Yoshiaki Watanabe, Yokohama-shi (JP); Seiki Harada, Zushi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/742,889

(22) Filed: Dec. 23, 2003

(30) Foreign Application Priority Data
Dec. 25, 2002 (JP) 2002-374605

(51) Int. Cl. A23D 7/00

(52) U.S. Cl. 426/601

(57) ABSTRACT

A low-fat oil-fried food, wherein a macerated ingredient material which has absorbed water of 5 to 80 parts by weight for 100 parts by weight of the ingredient material is fried after being subjected to preliminary heating with a microwave; preliminary heating provides heating within the range in which no naked-eye distinguishable change is caused to the ingredient material; the content of oil or fat is ¾ or less of the content of oil or fat for a similar oil-fried food which is obtained by frying without performing preliminary heating; the microwave high-frequency output is 100 to 400 W; by coating the ingredient material with a coating material, the ingredient material can be heated up to the core, even if the time period for frying is shortened; and thus the time period for frying can be shortened for preventing an excessive amount of lipid from being provided for the food.

### FIELD OF THE INVENTION

The present invention relates to a low-fat oil-fried food having a flavor peculiar to the oil-fried food, while providing a small amount of lipid, and thus a plain taste.

### BACKGROUND

Oil-fried foods, such as tempura and fry, are foods with which a part of the moisture in the ingredient material has been replaced with oil. They can be generally obtained by placing the ingredient material coated or not coated with a coating material in hot oil to heat up it to the core.

Conventional oil-fried foods provide a rich taste, but offer such drawbacks that the high content of oil or fat imposes a great load on the stomach, they are heavy, and it takes a long time for them to be digested. In addition, with them, the moisture in the ingredient material is replaced with oil or fat, and thus the total amount of moisture is reduced, which tends to cause the ingredient material in them to be harder.

To manufacture oil-fried foods, it is essential to heat up the ingredient material to the core in hot oil or fat. On the other hand, the content of oil or fat in the oil-fried food is increased roughly in proportion to the time period for frying, thus conventional oil-fried foods are oily, a large amount of oil being absorbed by them. Then, the technology has been demanded which can reduce the content of lipid in the oil-fried food while heating up the ingredient material to the core, and improve the flavor, securing the water which is bound to the tissue.

### SUMMARY OF THE INVENTION

The present invention is characterized in that a macerated ingredient material which has absorbed water of 5 to 80 parts by weight for 100 parts by weight of the ingredient material is fried after being subjected to the preliminary heating with a microwave; the preliminary heating provides heating within the range in which no naked-eye distinguishable change is caused to the ingredient material; the content of oil or fat is ¾ or less of the content of oil or fat for a similar oil-fried food which is obtained by frying without performing preliminary heating; the microwave high-frequency output is 100 to 400 W; and the ingredient material is coated with a coating material.

In other words, the present invention macerates the ingredient material, increasing the amount of free water in the ingredient material. The water bound to the cellular tissue is secured, and only the added free water, which is low in the degree of bonding to the tissue, is replaced with oil or fat, thus it is prevented that the ingredient material is hardened and the flavor is reduced.

First, the ingredient material is heated and then in-terrupted at the stage where the solidification of the protein and the change of the starch into alpha starch cannot be distinguished by the naked eye. Even if it is impossible to make visual discrimination, the heating or cooking of the food is progressed, and the food absorbs the energy to be transformed at the cell level. It has been found that preliminary heating until such state is reached can be performed by using the microwave, and this finding has led to the development of the present invention. The moisture which is evaporated by microwave heating is the added free water, and the water which is bound to the cellular tissue will not be evaporated.

Microwave heating provides means which allows heating the food relatively uniformly from the inside, however, general microwave heating produces portions which are locally, earlier, and intensely heated. With the present invention, the preliminary heating is performed uniformly with a microwave providing a high-frequency output of 400 W or less, and is interrupted at the stage where the change of the ingredient material cannot be distinguished by the naked eye, and the subsequent heating is carried out by the frying. As the result of the preliminary heating being performed with microwave, the time period for frying is extremely shortened, and thus the content of oil or fat in the manufactured oil-fried food is drastically reduced. In addition, the finish heating is provided by the frying, which results in the taste of the oil-fried food being maintained and a plain delicious oil-fried food being obtained.

### DETAILED DESCRIPTION OF THE INVENTION

The term “ingredient material” used in this specification is a term referring to any base materials which have con-ventionally been used as main materials for cookeries, such as tempura, fry, kara'age (frying with kara'age powder as a coat), and French fry (frying without coating), including meats, such as beef, pork, and chicken; sea foods, such as shrimp, cuttlefish, oyster, and fish; greenstuffs, such as eggplant, mushroom, and green pepper.

The term “oil-fried food” refers to a food produced by frying the ingredient material and coating in oil, French fry meaning frying only the ingredient material. Further, a food produced by attaching a fried coat to an ingredient material is also included in the category of oil-fried food.

To macerate ingredient materials, salts, such as common salt, potassium chloride, and calcium chloride; carbonates, such as sodium carbonate, potassium carbonate, and sodium bicarbonate; phosphates, such as sodium phosphate, sodium polyphosphate, sodium pyrophosphate; organic acids, such as citric acid and malic acid; organic salts, such as sodium citrate and sodium malate; polysaccharides, such as carra-geenan and arginic acid; enzymes; such as protease, lipase, and amylase; amino acid; peptide and polypeptide; proteins, such as gelatin, casein, and albumen; emulsification sta-bilizers, such as albumen and fatty acid ester; various seasonings; and fermentations are appropriately dissolved in the water to be absorbed by the ingredient materials.

In order to cause the ingredient material to absorb the water, an injector is used for injection of the water toward the ingredient material or a tumbler is employed for tumbling the ingredient material. The water absorbed is not provided as bound water, thus when the ingredient material is microwave heated, the water absorbed is vaporized prior to the bound water, and when the ingredient material is fried in oil, the water absorbed is evaporated prior to the bound water, being replaced with oil. Therefore, an oil-fried food containing a puffy and soft ingredient material can be obtained.

The amount of water to be absorbed by the ingredient material is 5 to 80% by mass of the ingredient material, preferably, 10 to 60% by mass thereof. Under 5% by mass, the bound water is evaporated, resulting in the ingredient material being hardened, and thus the effect of addition of water being not sufficiently provided, while over 80% by mass, the oil-fried food will be sloppy.

The term “preliminary heating” used in this specification refers to preliminary cookery heating that is performed by slowly heating the fool materials and terminating the heating before occurrence of a color change or the like which allows judgment by the naked eye that the food materials have been boiled. Even if the food materials are cooked to such a degree, they have absorbed the energy, which extremely shortens the time required for subsequent cookery heating. Preliminary heating is performed by using microwave at a temperature as low as possible. The high-frequency output is 100 to 400 W, preferably, 150 to 350 W. Under 100 W, the preliminary heating will require a longer time, while over 400 W, the temperature will be partially raised with occurrence of a change allowing judgment by the naked eye that the food materials have been boiled, resulting in the texture of the oil-fried food being deteriorated.

The ingredient material is generally coated with such a coating material as kara'age powder, batter, or bread crumbs. It is preferable that microwave heating be carried out after the ingredient material being coated with a coating material.

Frying of a particular ingredient material is performed by placing it in the oil or fat heated to 140 to 240 deg C., preferably, 150 to 200 deg C. One of the advantages of preliminary heating is such that, although frying a pork cutlet for business use generally requires 5 to 6 minutes, preliminary heating can shorten the time period down to 2 minutes or less. In other words, the frying time can be reduced by 30 to 80%. Reduction in the frying time leads to the amount of oil absorbed being reduced, which prevents oily texture and heaviness, provides a plain oil-fried food, and lowers the amount of oil consumption.

The content of lipid in the oil-fried food subjected to the preliminary heating according to the present invention is ¾ or less, preferably, ½ or less, of that of lipid in the food which has been produced by frying the same food material without preliminary heating.

Frying for a long period of time may cause smoking and smelling. The principal components of the smoke produced in frying are fatty acids, aldehydes, ketones, alcohols, and other volatile decomposition products of the oil. The principal component of the smell is acrolein, which is produced by dehydration of the glycerin. These are causative agents for oil drunkenness, and it is preferable that the amount be as small as possible. With the present invention, these are practically not produced because the time period for frying is short.

Any food material which has been subjected to the pre-liminary heating can be stored by freezing. When frying it as frozen or after being thawed, the period of time for frying is shortened by the time corresponding to the energy required for preliminary heating. The oil-fried food can be stored by freezing, and heated with an oven or an electronic oven for eating.

### EXAMPLE 1 AND COMPARATIVE EXAMPLE 1, 2

100 kg of pork loins were sliced into pieces of 45 to 50 g for pork cutlet, and an injector was used for injection. Then a vacuum tumbler was used for tumbling them for 8 hr to obtain macerated pork loins which absorbed 25 kg of water.

The 25 kg of water added contained the following materials:

Soybean protein decomposition products (manufactured by FUJI OIL CO., LTD.): 5 kg

Salt: 200 g

Polymerized phosphate formulation (manufactured by TAKEDA CHEMICAL INDUSTRIES, LTD.): 900 g

Amino acid and yeast extract seasoning: 800 g

10 kg of dusting powder for pork cutlet (manufactured by NIHON SHOKUHIN KAKO CO., LTD.) was deposited onto the surfaces of the macerated pork loins, which were then passed through batter liquid before 12 kg of bread crumbs being deposited onto them to obtain products for pork cutlet.

The products for pork cutlet obtained were placed on the tray, and subjected to the preliminary heating by use of a microwave continuous heater under the conditions of a voltage of 200 V and a high-frequency output of 300 W for 3 min per product for pork cutlet (approx. 80 g) as mentioned above. The products for pork cutlet subjected to the preliminary heating were fried in corn oil at 175 to 180 deg C. for 3 min to obtain low-fat pork cutlets of the embodiment 1.

Separately, in the same manner as that in the embodiment 1 except that preliminary heating was not performed, pork cutlets were produced. Because the preliminary heating was omitted, the time period required for the ingredient material being heated up to the core was as long as 7 min. This work was designated the comparative example 1.

Separately, in the same manner as that in the embodiment 1 except that the macerating process and the preliminary heating one were omitted, pork cutlets were produced. In this case, the time period required for the ingredient material being heated up to the core was as long as 6.5 min. This work was designated the comparative example 2.

The pork cutlets obtained in the embodiment 1, the comparative example 1, and the comparative example 2 were evaluated for texture and taste by 10 panelists. Specifically, the texture of the coat (the crispy or sticky feeling), the texture of the ingredient material (the soft feeling), and the taste (the combined taste of the ingredient material, coat, and oil, or the odd taste peculiar to the oil) were evaluated in 5 steps of 2, 1, 0, −1, and −2, and the total values were given in Table 1.

Separately, for the embodiment 1, the comparative example 1, and the comparative example 2, the respective contents of lipid in the oil-fried food of 100 g were given in Table 2 together with the respective time periods for frying.

TABLE 1

| | Immediately | | | 5 hr | | |
|---|---|---|---|---|---|---|
| | after frying | | | after frying | | |
| | | Texture | | | Texture | |
| | Texture | of | | Texture | of | |
| | of | ingredient | | of | ingredient | |
| | coat | material | Taste | coat | material | Taste |
| Embodiment 1 | 18 | 19 | 20 | 7 | 18 | 15 |
| Comparative | 19 | 12 | 9 | −11 | 10 | −2 |
| example 1 | | | | | | |
| Comparative | 18 | 1 | −2 | 1 | −4 | −3 |
| example 2 | | | | | | |

TABLE 2

| | Time period | |
|---|---|---|
| | for frying | Lipid per 100 g |
| | (min) | (g) |
| Embodiment 1 | 3 | 13 |
| Comparative | 7 | 22 |
| example 1 | | |
| Comparative | 6.5 | 19 |
| example 2 | | |

As can be seen from Table 1 and Table 2, the oil-fried food according to the present invention was superior to the conventional items in texture and taste both immediately after frying and 5 hr after frying. In addition, it has been found that the time period for frying is closely related to the content of lipid, and by performing preliminary heating, the content of lipid is substantially reduced. In fact, the amount of corn oil consumed in the fryer in the embodiment 1 was approx. 30% smaller than those in the comparative example 1 and the comparative example 2.

The smoking and smelling in the frying were enhanced in the late phase of the frying; in the embodiment 1, they were practically not perceived; in the comparative example 2, the degree of them was normal; and in the comparative example 2, the amount of them was large.

The macerated pork loins which were subjected to the preliminary heating after the bread crumbs being deposited onto them in the embodiment 1 were quick frozen at −40 deg C. in 1 hour, and stored at −18 deg C. for one month. This work was designated the embodiment 1-1. The macerated pork loin which was not subjected to the preliminary heating after the bread crumbs being deposited onto it in the comparative example 1 was quick frozen at −40 deg C. in 1 hour, and stored at −18 deg C. for one month. This work was designated the comparative example 1-1. The pork loin which was not macerated, and not subjected to the preliminary heating after the bread crumbs being deposited onto it in the comparative example 2 was quick frozen at −40 deg C. in 1 hour, and stored at −18 deg C. for one month. This work was designated the comparative example 2-1. The pork loins for the embodiment 1, the comparative example 1-1, and the comparative example 2-1 were naturally thawed, and fried in corn oil at 175 to 180 deg C., respectively. The time period for frying was 3.5 min for the embodiment 1, 7.5 min for the comparative example 1-1, and 7 min for the comparative example 2-1.

Immediately after the frying and 5 hr after the frying, the respective pork cutlets were evaluated for texture and taste by 10 panelists in the same manner as that for the embodiment 1, and the results are given in Table 3.

TABLE 3

| | Immediately | | | 5 hr | | |
|---|---|---|---|---|---|---|
| | after frying | | | after frying | | |
| | | Texture | | | Texture | |
| | Texture | of | | Texture | of | |
| | of | ingredient | | of | ingredient | |
| | coat | material | Taste | coat | material | Taste |
| Embodiment | 19 | 7 | 11 | 7 | 12 | 0 |
| 1-1 | | | | | | |
| Comparative | 8 | −1 | −2 | −4 | −5 | −15 |
| example 1-1 | | | | | | |
| Comparative | 8 | −2 | −3 | −6 | −9 | −10 |
| example 2-1 | | | | | | |

When any product for pork cutlet is stored by freezing, it is inevitable that the quality is deteriorated, resulting from the refrigeration, however, the pork cutlets according to the present invention obtained a relatively high evaluation.

The pork cutlets obtained in the embodiment 1, the comparative example 1, and the comparative example 2 were rapidly frozen at −40 deg C. in 1 hour immediately after the frying, and stored at −18 deg C. for one month. The pork cutlets obtained in the experiment 1 and stored by freezing were designated the embodiment 1-2, those obtained in the comparative example 1 and stored by freezing the comparative example 1-2, and those obtained in the comparative example 2 and stored by freezing the comparative example 2-2. After being naturally thawed, these were placed on the tray, and heated with an electronic oven rated at 100 V, 800 W for 1 min per piece. The respective reheated pork cutlets were evaluated for texture and taste by 10 panelists in the same manner as that in the embodiment 1, and the results are given in Table 4.

TABLE 4

| | | Texture of | |
|---|---|---|---|
| | Texture | ingredient | |
| | of coat | material | Taste |
| Embodiment | 12 | 10 | 5 |
| 1-2 | | | |
| Comparative | 14 | −11 | −7 |
| example 1-2 | | | |
| Comparative | 11 | −18 | −5 |
| example 2-2 | | | |

### EXAMPLE 2 AND COMPARATIVE EXAMPLE 3, 4

100 kg of chicken rounds were sliced into pieces of 25 to 30 g for kara'age, and then a vacuum tumbler was used for tumbling them for 2 hr to obtain macerated chicken rounds which absorbed 25 kg of water.

The 25 kg of water added contained the following materials:

Albumen decomposition products (manufactured by Q.P. Cor-poration) 4 kg

Salt: 200 g

Polymerized phosphate formulation (manufactured by TAKEDA CHEMICAL INDUSTRIES, LTD.): 900 g

Amino acid and yeast extract seasoning: 800 g

8 kg of dusting powder for chicken kara'age (manufactured by NIHON SHOKKEN CO., LTD.) was deposited onto the surfaces of the macerated chicken rounds to obtain products for chicken kara'age.

The products for chicken kara'age obtained were placed on the tray, and subjected to the preliminary heating by use of a microwave continuous heater under the conditions of a voltage of 200 V and a high-frequency output of 300 W for 2 min per product for chicken kara'age (approx. 40 g) as mentioned above. The products for chicken kara'age subjected to the preliminary heating were fried in corn oil at 175 to 180 deg C. for 2 min to obtain low-fat chicken kara'age products of the embodiment 2.

Separately, in the same manner as that in the embodiment 2 except that preliminary heating was not performed, chicken kara'age pieces were produced. Because the preliminary heating was omitted, the time period required for the in-gredient material being heated up to the core was as long as 4.5 min. This work was designated the comparative example 3.

Separately, in the same manner as that in the embodiment 2 except that the macerating process and the preliminary heating one were omitted, chicken kara'age pieces were produced. In this case, the time period required for the ingredient material being heated up to the core was as long as 4 min. This work was designated the comparative example 4.

The chicken kara'age pieces obtained in the embodiment 2, the comparative example 3, and the comparative example 4 were evaluated for texture and taste by 10 panelists in the same manner as that in the embodiment 1, and the results are given in Table 5.

Separately, for the embodiment 2, the comparative example 3, and the comparative example 4, the respective contents of lipid in the oil-fried food of 100 g were given in Table 6 together with the respective time periods for frying.

TABLE 5

| | | Texture of | |
|---|---|---|---|
| | Texture | ingredient | |
| | of coat | material | Taste |
| Embodiment 2 | 19 | 17 | 20 |
| Comparative | 18 | 9 | 11 |
| example 3 | | | |
| Comparative | 19 | 5 | 2 |
| example 4 | | | |

TABLE 6

| | Time period | |
|---|---|---|
| | for frying | Lipid per 100 g |
| | (min) | (g) |
| Embodiment 2 | 2 | 6.5 |
| Comparative | 4.5 | 15.4 |
| example 3 | | |
| Comparative | 4 | 13.3 |
| example 4 | | |

The macerated chicken rounds subjected to the preliminary heating after the dusting powder being deposited onto them in the embodiment 2 were rapidly frozen at −40 deg C. in 1 hr, and stored at −18 deg C. for one month. This work was designated the embodiment 2-1. The macerated chicken rounds subjected to the preliminary heating after the dusting powder being deposited onto them in the comparative example 3 were rapidly frozen at −40 deg C. in 1 hr, and stored at —18 deg C. for one month. This work was designated the comparative example 3-1. The macerated chicken rounds subjected to the preliminary heating after the dusting powder being deposited onto them in the comparative example 4 were rapidly frozen at −40 deg C. in 1 hr, and stored at −18 deg C. for one month. This work was designated the comparative example 4-1. The chicken kara'age pieces for the embodiment 2-1, the comparative example 3-1, and the comparative example 4-1 were naturally thawed, and fried in corn oil at 175 to 180 deg C., respectively. The time period for frying was 2 min for the embodiment 2-1, 4.5 min for the comparative example 3-1, and 4 min for the comparative example 4-1.

Immediately after the frying and 5 hr after the frying, the respective chicken kara'age pieces were evaluated for texture and taste by 10 panelists in the same manner as that for the embodiment 1, and the results are given in Table 7. The chicken kara'age pieces according to the present invention obtained a relatively high evaluation, even if they were stored by freezing.

TABLE 7

| | Immediately | | | 5 hr | | |
|---|---|---|---|---|---|---|
| | after frying | | | after frying | | |
| | | Texture | | | Texture | |
| | Texture | of | | Texture | of | |
| | of | ingredient | | of | ingredient | |
| | coat | material | Taste | coat | material | Taste |
| Embodiment | 21 | 11 | 12 | 15 | 7 | −1 |
| 2-1 | | | | | | |
| Comparative | 12 | −2 | 0 | 4 | 0 | −11 |
| example 3-1 | | | | | | |
| Comparative | 11 | −2 | −1 | −9 | −11 | −8 |
| example 4-1 | | | | | | |

The chicken kara'age pieces obtained in the embodiment 2, the comparative example 3, and the comparative example 4 were rapidly frozen at −40 deg C. in 1 hour immediately after the frying, and stored at −18 deg C. for one month. The chicken kara'age pieces obtained in the experiment 2 and stored by freezing were designated the embodiment 2-2, those obtained in the comparative example 3 and stored by freezing the comparative example 3-2, and those obtained in the comparative example 4 and stored by freezing the comparative example 4-2. After being naturally thawed, these were placed on the tray, and heated with a household infrared inverter rated at 100 V, 1000 W for 50 see per piece. The respective reheated chicken kara'age pieces were evaluated for texture and taste by 10 panelists in the same manner as that in the embodiment 1, and the results are given in Table 8.

TABLE 8

| | | Texture of | |
|---|---|---|---|
| | Texture | ingredient | |
| | of coat | material | Taste |
| Embodiment | 13 | 18 | 14 |
| 2-2 | | | |
| Comparative | 4 | −1 | 11 |
| example 3-2 | | | |
| Comparative | 3 | −8 | 1 |
| example 4-2 | | | |

### EXAMPLE 3 AND COMPARATIVE EXAMPLE 5, 6

100 kg of frozen shrimps for tempura (Black Tiger from Thailand, sizes 21 to 25, shell removed, and tail on) were thawed, and the backs of the shrimps were slit. Then a vacuum tumbler was used for tumbling them for 1 hr to obtain macerated shrimps which absorbed 15 kg of water.

The 15 kg of water added contained the following materials:

Salt: 200 g

Polymerized phosphate formulation for fishery products (manufactured by TAKEDA CHEMICAL INDUSTRIES, LTD.): 200 g

Amino acid and yeast extract seasoning: 900 g

8 kg of dusting powder for seafood processing (manufactured by NIHON SHOKKEN CO., LTD.) was deposited onto the surfaces of the macerated shrimps to obtain products for shrimp tempura.

The products for shrimp tempura obtained were placed on the tray, and subjected to the preliminary heating by use of a microwave continuous heater under the conditions of a voltage of 200 V and a high-frequency output of 300 W for 1 min per product for shrimp tempura (approx. 22 g) as mentioned above. Thus, the products for shrimp tempura that were preliminarily heated were obtained.

The obtained products for shrimp tempura were rapidly frozen at −40 deg C. in 1 hour, and stored at −18 deg C. for one month. The frozen products for shrimp tempura were thawed, passed through batter liquid, and fried in corn oil at 175 to 180 deg C. for 1.5 min to obtain low-fat shrimp tempura pieces of the embodiment 3.

Separately, in the same manner as that in the embodiment 3 except that preliminary heating was not performed, shrimp tempura pieces were produced. Because the preliminary heating was omitted, the time period required for the ingredient material being heated up to the core was as long as 3.5 min. This work was designated the comparative example 5.

Separately, in the same manner as that in the embodiment 3 except that the macerating process and the preliminary heating one were omitted, shrimp tempura pieces were produced. In this case, the time period required for the ingredient material being heated up to the core was as long as 3 min. This work was designated the comparative example 6.

The shrimp tempura pieces obtained in the embodiment 3, the comparative example 5, and the comparative example 6 were evaluated for texture and taste by 10 panelists in the same manner as that in the embodiment 1, and the results are given in Table 9.

Separately, for the embodiment 3, the comparative example 5, and the comparative example 6, the respective contents of lipid in the oil-fried food of 100 g were given in Table 10 together with the respective time periods for frying.

The shrimp tempura pieces according to the present in-vention were excellent in texture and taste, and offered a small content of lipid, when compared to the conventional products.

TABLE 9

| | | Texture of | |
|---|---|---|---|
| | Texture | ingredient | |
| | of coat | material | Taste |
| Embodiment 3 | 19 | 13 | 12 |
| Comparative | 11 | 2 | 2 |
| example 5 | | | |
| Comparative | 1 | −5 | −1 |
| example 6 | | | |

TABLE 10

| | Time period | |
|---|---|---|
| | for frying | Lipid per 100 g |
| | (min) | (g) |
| Embodiment 3 | 3 | 4.0 |
| Comparative | 4.5 | 8.5 |
| example 5 | | |
| Comparative | 4 | 7.5 |
| example 6 | | |

What is claimed is:

1. A oil-fried food, wherein a macerated ingredient material which has absorbed water of 5 to 80 parts by weight for 100 parts by weight of the ingredient material is fried after being subjected to preliminary heating with a microwave.

2. A low-fat oil-fried food, wherein a macerated in-gredient material which has absorbed water of 5 to 80 parts by weight for 100 parts by weight of the ingredient material is fried after being subjected to preliminary heating with a microwave and the ingredient material being frozen.

3. A low-fat oil-fried food, wherein a macerated in-gredient material which has absorbed water of 5 to 80 parts by weight for 100 parts by weight of the ingredient material is frozen after being subjected to preliminary heating with a microwave and then fried.

4. The low-fat oil-fried food of claim 1, wherein preliminary heating provides heating within the range in which no naked-eye distinguishable change is caused to the ingredient material.

5. The low-fat oil-fried food of claim 1, wherein the content of oil or fat is ¾ or less of the content of oil or fat for a similar oil-fried food which has been obtained by frying without performing preliminary heating.

6. The low-fat oil-fried food of claim 1, wherein the content of oil or fat is ½ or less of the content of oil or fat for a similar oil-fried food which has been obtained by frying without performing preliminary heating.

7. The low-fat oil-fried food of claim 1, wherein the microwave high-frequency output is 100 to 400 W.

8. The low-fat oil-fried food of claim 1, wherein the microwave high-frequency output is 150 to 350 W.

9. The low-fat oil-fried food of claim 1, wherein the ingredient material is coated with a coating material.
